(19) United States
(12) Patent Application Publication
(10) Pub. No.: US 2017/0060977 A1
(43) Pub. Date: Mar. 2, 2017

(54) DATA PREPARATION FOR DATA MINING

(71) Applicant: BloomReach, Inc., Mountain View, CA (US)

(72) Inventors: Rong Pan, Santa Clara, CA (US); Yue Yu, Sunnyvale, CA (US)

(21) Appl. No.: 14/841,528

(22) Filed: Aug. 31, 2015

(51) Int. Cl. G06F 17/30

(52) U.S. Cl. CPC G06F 17/30592; G06F 17/30958; G06F 17/30292

(57) ABSTRACT

A system for preparing data for data mining can be utilized to automate translation of raw data to denormalized high-dimensional data in a format of vectors by processing the raw data in a computer cluster processing system. In embodiments, a system for preparing data for data mining includes a data assemble definition interface, a data assemble plan generator, a data assemble plan compiler, a cluster execution module, and a data warehouse module. A user may input a data schema that specifies the raw data input, feature extraction or data translate method, output attributes, and output layer attributes. Embodiments of the present disclosure can interpret the data schema, plan a large data processing work flow for a computer cluster, execute the computer cluster process, and output the data in the format specified by the user in the data schema.

### BACKGROUND

In recent years, there has been increasing commercial interest in processing big data. The term “big data” may generally mean data sets that are large or complex enough that typical methods for processing and/or organizing the data may be inefficient and/or inadequate. Analysis of large data sets can be useful to find correlations and/or identify relevant trends. E-commerce and other Internet-based activities continue to result in the generation of large amounts of semi-structured data.

Such semi-structured big data may be found within varied sources such as web pages, logs of page views, click streams, transaction logs, social network feeds, news feeds, application logs, application server logs, and system logs. A large portion of data from these types of semi-structured data sources may not fit well into traditional databases. Some data sources may include some inherent structure, but that structure may not be uniform, depending on each data source. Further, the structure for each source of data may change over time and may exhibit varied levels of organization across different data sources.

To aid in organizing and/or processing big data, various platforms and tools have been developed. Hadoop is an open-source platform for managing distributed processing of big data over computer clusters. To aid in managing Hadoop processes, Cascading is an application development framework for building big data applications. Cascading acts as an abstraction layer to run Hadoop processes.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a block diagram illustrating a data preparation system according to one embodiment of the present disclosure;

FIG. 2 is a schematic illustrating raw data according to one embodiment of the present disclosure; and

FIG. 3 is a block diagram illustrating a data preparation method according to one embodiment of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

The present disclosure is directed to methods, systems, and computer programs for preparing large scale raw data for subsequent data mining. In the following description, reference is made to the accompanying drawings that form a part hereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

According to various embodiments of the present disclosure, systems and methods described herein are adapted to assemble and/or translate large scale raw format data that represents a link graph for subsequent data mining. As used herein, “raw data” includes raw log files or raw structured data, for example in text format or any structured data, such as Protocol Buffers (“protobuf”), JavaScript Object Notation (“JSON”), Extensible Markup Language (“XML”), and plain text. According to embodiments, a schema definition is created by a user to specify the input, feature extraction or data translate method, and output layer and output attributes from processing the raw data. In embodiments, the outputs of processes include multiple layer high-dimensional data in a format of vectors that are ready for subsequent data mining.

According to various embodiments, one format for such data vectors may be may be expressed as:

node 1: [attr1:val1, attr2 :val2, attr3 :val3, . . . , attrN:valN]

Where “attr1,” “attr2,” . . . , “attrN” are the name of each value (or the index of the value). Each value of a vector can be a number, a string, a boolean value, or another vector, for example:

attr1:val1=102;

attr2:val2=“abc”;

attr3:val3=true; and

attr4:val4=[attr4_1:val4_1, attr4_2:val4_2, . . . , attr4_N:val4_N];

Where the elements of the vector “attr4” can each comprise a number, a string, a Boolean value, or another vector.

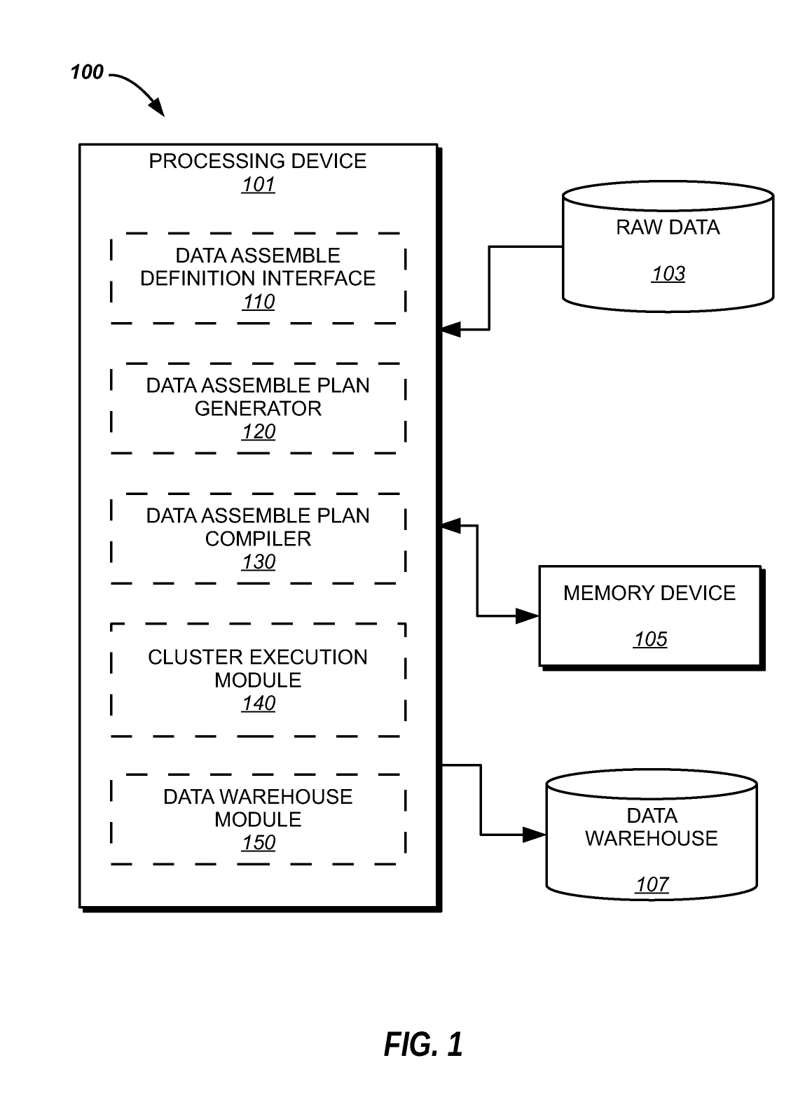

FIG. 1 is a block diagram depicting a data preparation system 100 according to one embodiment of the present disclosure. In an embodiment, data preparation system 100 includes a processing device 101 and memory device 105. In one embodiment, memory device 105 has computer-readable instructions to direct processing device 101 to implement a data assemble definition interface 110, a data assemble plan generator 120, a data assemble plan compiler 130, a cluster execution module 140, and a data warehouse module 150. In the illustrated embodiment, data preparation system 100 further includes raw data store 103 and data warehouse 107.

In one embodiment, data assemble definition interface 110 is adapted to receive configurations from one or more users and generate a data schema. According to various embodiments, a data schema comprises definitions specifying the input, feature extraction or data translate method, and output layer and output attributes for the raw data. A user may input selections for the desired data schema through a user interface presented by data assemble definition interface 110.

According to embodiments, data assemble definition interface 110 provides data schema options that are based on attributes available in the raw source data. Accordingly, in one embodiment, data assemble definition interface 110 is configured to carry out a preliminary analysis of the raw data to determine potential attributes that the user may select to construct the data schema.

In one embodiment, data assemble plan generator 120 is adapted to interpret the data schema generated by data assemble definition interface 110 and generate a data assemble plan that targets the selected data indicated in the data schema.

In one embodiment, data assemble plan compiler 130 is adapted to create a data processing work flow for a computer cluster, for example using Cascading for a Hadoop cluster.

In one embodiment, cluster execution module 140 is adapted to execute the data processing work flow on a computer cluster to process and assemble the raw data according to the data schema. In one embodiment, cluster execution module 140 is configured to transmit the processed data to data warehouse module 150. According to various embodiments, data assemble plan compiler 130 and cluster execution module 140 can act as a layer of abstraction over the computer cluster by managing the nodes of the computer cluster and other resources through the big data processing operations.

In one embodiment, data warehouse module 150 is adapted to receive the processed data and store said data at data warehouse 107. In embodiments, data warehouse 107 comprises an integrated repository of data that was processed by the computer cluster.

According to various embodiments, the foregoing components and/or modules may be embodied as computer-readable instructions stored on various types of media. Any combination of one or more computer-usable or computer-readable media may be utilized in various embodiments of the present disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments of the present disclosure may be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flowcharts and block diagram in the attached figures illustrate the architecture, functionality, and operation of possible implementations of systems, methods, and computer program products according to various embodiments of the present disclosure. In this regard, each block in the flowcharts or block diagram may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagram block or blocks.

In operation, embodiments of the present disclosure are configured to assemble and translate large scale raw format data that represents link graph for subsequent data mining according to data schema definitions provided by a user. In embodiments, the data schema can specify the input, feature extraction or data translate method, and/or output layer and output attributes. In embodiments, the data schema can define how the raw data will be assembled and/or organized.

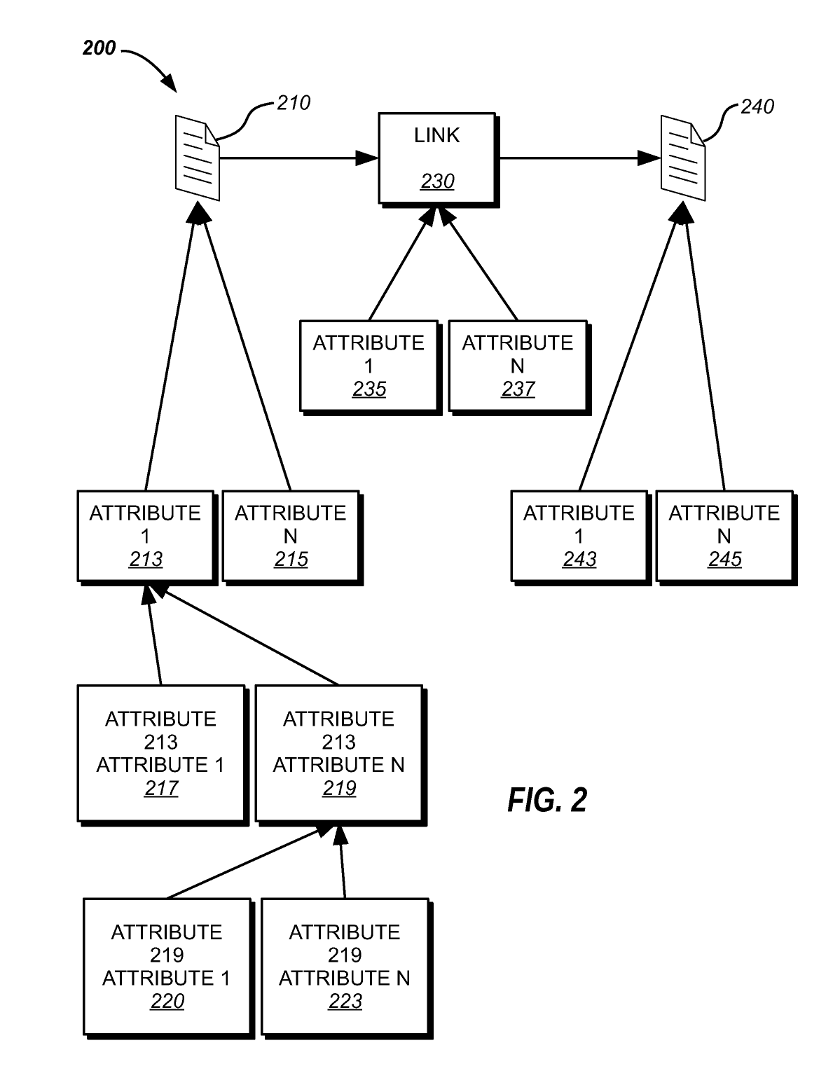

In one embodiment, raw data comprises website link graph data. Website link graph data may include page data and metadata, links between pages, attributes of pages, attributes of links, and attributes of attributes. Referring to FIG. 2, an exemplary link graph 200 is illustrated. According to various embodiments, page 210 comprises a link 230 to page 240. Link 230 comprises one or more link attributes, which are set forth in FIG. 2 as attribute 1 235 and attribute N 237. Page 210 includes one or more attributes, which are set forth in FIG. 2 as attribute 1 213 and attribute N 215. Page 240 likewise includes one or more attributes, which are set forth in FIG. 2 as attribute 1 243 and attribute N 245. It is to be understood that a page, such as pages 210, 240 may include any number of page attributes such as attributes 213, 215, 243, 245. In embodiments, such attributes may be sequentially designated with numerals 1, 2, 3, . . . N.

According to the embodiment depicted in FIG. 2, attribute 1 213 has attribute 1 217 and attribute N 219. As depicted in FIG. 2, attribute N 219 has attribute 1 220 and attribute N 223. In embodiments, pages, links, page attributes, link attributes, and attribute attributes may each have virtually any number of respective attributes. In embodiments, graph data may be translated from data and/or metadata of one or more pages. In various embodiments, raw data is embodied as protobuf, JSON, XML, plain text, or other structured or unstructured data objects that represent the various pages, links, page attributes, link attributes, and attribute attributes that are targeted for data collection and/or processing. In embodiments, a URL may have numerous tags associated with it. In some cases, URLs may typically have 20-40 associated tags. Such tags may be interpreted as attributes.

In one embodiment, assume that a first page, referred to herein as pageₓ, has a link to another page page_{y}. The link from pageₓ to page_{y} may be expressed as “pageₓ outlink to page_{y}” or “page_{y} inlinked from pageₓ.” A data schema to capture data, metadata, and other types of attributes from pageₓ and page_{y} may be expressed as:

source: pageₓ to page_{y},

features of pageₓ has

[attributes of pageₓ]

source: pageₓ to page_{y},

features of page_{y} has

[attributes of page_{y}]

In embodiments where a third page page_{z} comprises a link to pageₓ, a data schema to capture data, metadata, and other types of attributes from pageₓ, page_{y}, and page_{z} may be expressed as:

source: pageₓ,

features of pageₓ has:

[attributes of pageₓ]

for page_{y} inlinked from pageₓ:
features of page_{y} has

[attributes of page_{y}]

for page_{z} outlinked to pageₓ:
features of page_{z} has

[attributes of page_{z}]

According to embodiments, each feature in the data schema can be defined as multiple layer high-dimensional data according to the following generalized example:

| | |
|---|---|
| 1 | vector_0{ |

| | |
|---|---|
| 2 | data_0_1:input_source, identification field, feature field, feature extraction method, default |

value

| | |
|---|---|
| 3 | data_0_2:input_source, identification field, feature field, feature extraction method, default |

value

| | |
|---|---|
| 4 | { |

| | |
|---|---|
| 5 | data 0_2_1:input_source, identification field, feature field, feature extraction method, |

default value

| | |
|---|---|
| 6 | data 0_2_2:input_source, identification field, feature field, feature extraction method, |

default value

| | |
|---|---|
| 7 | [more data entries such as lines 2 or 3-8] |

| | |
|---|---|
| 8 | } |
| 9 | nested_vector_1 { |

| | |
|---|---|
| 10 | data_1_3:input_source, identification field, feature field, feature extraction method, |

default values

| | |
|---|---|
| 11 | [more data entries such as lines 2, 3-8, or 9-12] |

| | |
|---|---|
| 12 | } |
| 13 | [more data entries such as lines 2, 3-8, or 9-12] |

| | |
|---|---|
| 14 | } |

where: “vector_0” (line 1) is the vector data represented in lines 1-14 and the fields in line 2 define how to populate one value or multiple values in the vector vector_0 from one data entry; in particular:

“input_source” (line 2) is the local or remote file or database table from which data was extracted;

“identification field” (line 2) is the field from which the key of vector_0 can be identified;

“feature field” (line 2) is the field from which attributes and values can be extracted;

“feature extraction method” (line 2) indicates a method that uses the value from “feature field” as an input, applies specific transformation and/or computations, and outputs one or multiple attribute values. In embodiments, the method maps to a piece of software for the pipeline to execute; and

“default value” (line 2) is a default value to output if current data does not have an entry for the key.

In the foregoing example, lines 3-8 define how to populate one value or multiple values in the vector vector_0 from multiple data entries. In this example, lines 3-8 describe the nested definition to model the nested behavior of input data, which is illustrated by FIG. 2. Referring to lines 3-8 in particular:

lines 5, 6, and 7 describe how to generate an internal vector, which may be used as the input for line 3;

the key of the internal vector is identified by the “identification field” of each data entry definition on line 5, 6, and 7;

the key of the internal vector is also identified by the “feature field” of line 3;

the internal vector describes information about each value of the data in line 3 (in other words, for each value in line 3, lines 4-7 comprises a vector to describe it); and

the “feature extraction method” of line 3 takes the internal vectors as input, applies aggregation or transformation on them, and generates one or multiple values for vector_0.

In the foregoing example, lines 9-12 define how to populate nested vector nested_vector_1. The key of nested_vector_1 is the same as the key of vector_0, as both vectors describe the information of the same key. In the example, lines 9-12 describe the output nested vectors, which may follow the format of data vectors described above. In one embodiment, nested_vector_1 may be used to organize the output to best fit data storage and/or data mining applications.

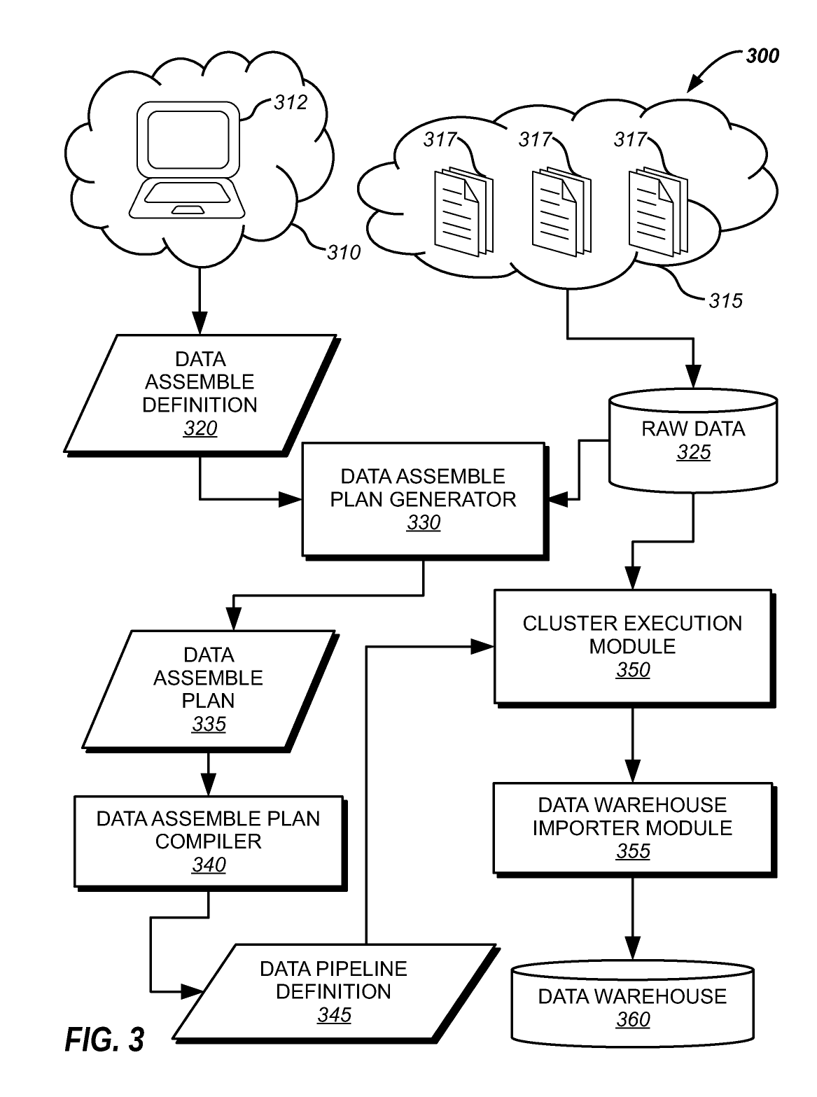

Referring to FIG. 3, an illustration of a data preparation process 300 is set forth according to one embodiment of the present disclosure. According to an embodiment, user 312 on network 310 submits a data schema, which is translated to data assemble definition 320. Link graph data is collected from pages 317 on network 315 and stored at raw data 325. In embodiments, pages 317 may be web pages or any other file types. Data assemble definition 320 and graph data at raw data 325 is transmitted to data assemble plan generator 330, which generates data assemble plan 335 by interpreting the data schema. In embodiments, data assemble plan 335 is created according to the data schema input by user 312 and the raw data 325 available from the source pages 317.

In embodiments, the data assemble plan compiler 340 can interpret the data assemble plan 335 and plan a large data processing work flow to assemble the information request in the data assemble definition 320. The processing work flow may be embodied in the data pipeline definition 345 prepared for cluster computer processing. In embodiments, data pipeline definition 345 is created on the Cascading platform for subsequent execution using a Hadoop cluster. In other embodiments, other platforms are utilized to create the data processing work flow for a computer cluster.

In embodiments, data pipeline definition 345 is executed on a computer cluster by cluster execution module 350. In one embodiment, the computer cluster comprises a Hadoop cluster. The computer cluster can follow data assemble plan 335 using data pipeline definition 345 to identify, assemble, and/or organize raw data 325 according to data assemble definition 320 and the data schema provided by user 312. In embodiments, MapReduce is implemented in the computer cluster to process and/or organize the data.

According to embodiments, processing on raw data 325 may include operations such as tabulating the data, counting frequencies of specified objects in the raw data, summing quantities in the raw data, or other operations as selected by user 312 in the data schema.

Assembled data can be stored by data warehouse importer module 355 at data warehouse 360. The data stored at data warehouse 360 is organized according to the data schema provided by user 312.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the disclosure.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed:

1. A computer-implemented method for preparing data for data mining, comprising:
retrieving raw data pages, wherein the raw data pages each have at least one attribute;
receiving a data schema defining an output data format and one or more output attributes;
at a data assemble plan generator, generating a data assemble plan for the one or more output attributes;
at a data assemble plan compiler, formulating a data pipeline definition according to the data assemble plan;
executing a computer cluster processing operation to process the data according to the data schema; and
at a data warehouse importer, storing the results of the computer cluster processing operation at a data warehouse.

2. The method claim 1, wherein the raw data comprises raw structured data.

3. The method claim 1, wherein formulating the data pipeline definition comprises creating a Cascading data processing workflow.

4. The method claim 1, wherein executing the computer cluster processing operation further comprises implementing a Hadoop MapReduce job.

5. The method claim 1, wherein the raw data comprises pages connected by links.

6. The method claim 5, wherein the raw data further comprises page attributes describing the pages and link attributes describing the links.

7. The method claim 6, wherein the raw data further comprises page attribute attributes describing the page attributes.

8. The method of claim 1, wherein the raw data was drawn from a data source selected from the group consisting of web pages, logs of page views, click streams, transaction logs, social network feeds, news feeds, application logs, application server logs, and system logs.

9. The method of claim 1, wherein the one or more output attributes comprise selected ones of page attributes, link attributes, and attribute attributes.

10. A computer-implemented method for preparing data for data mining, comprising:
receiving a user selection that identifies raw data and a desired data output;
generating a data schema for the user selection;
at a data assemble plan generator, interpreting the data schema to create a data assemble plan;
at a data assemble plan compiler, planning a data processing work flow to follow the data assemble plan;
at a computer cluster, processing the raw data according to the data schema; and
at the computer cluster, organizing the raw data according to the data schema.

11. The method of claim 10, further comprising storing the data at a data warehouse.

12. The method of claim 10, wherein processing the data further comprises featurizing the data.

13. The method of claim 10, wherein the raw data comprises raw structured data.

14. The method of claim 10, wherein planning a data processing work flow comprises creating a Cascading data processing workflow.

15. The method of claim 10, wherein processing the raw data further comprises implementing a Hadoop MapReduce job.

16. The method of claim 10, wherein the raw data comprises pages connected by links, page attributes describing the pages, and link attributes describing the links

17. The method of claim 10, wherein the raw data was drawn from a data source selected from the group consisting of web pages, logs of page views, click streams, transaction logs, social network feeds, news feeds, application logs, application server logs, and system logs.

18. The method of claim 10, wherein the desired data output comprises selected ones of page attributes, link attributes, and attribute attributes.

19. A computer system for preparing data for data mining comprising:
a data preparation computer device comprising a memory and a processing device, the memory storing computer-readable instructions directing the processing device to:
retrieve raw data pages, wherein the raw data pages each have at least one attribute;
receive a data schema defining an output data format and one or more output attributes;
generate a data assemble plan for the one or more output attributes;
formulate a data pipeline definition according to the data assemble plan;
execute a computer cluster processing operation to process the data according to the data schema and organize the data according to the output data format; and
store the results of the computer cluster processing operation at a data warehouse.

20. The system of claim 19, further comprising a Hadoop cluster.
